(19) United States
(12) Patent Application Publication
(10) Pub. No.: US 2026/0048686 A1
(43) Pub. Date: Feb. 19, 2026

(54) DRIVING MOTOR USING BLDC MOTOR, AND SEAT ACTUATOR USING SAME

(71) Applicant: AMOTECH CO., LTD, Incheon (KR)

(72) Inventors: Jong Hwa SHIN, Incheon (KR); Byung Soo KIM, Incheon (KR)

(21) Appl. No.: 19/103,229

(22) PCT Filed: Aug. 10, 2023
(86) PCT No.: PCT/KR2023/011859

§ 371 Date: Feb. 11, 2025

(30) Foreign Application Priority Data
Aug. 12, 2022 (KR) 10-2022-0101172
Aug. 17, 2022 (KR) 10-2022-0102642

(51) Int. Cl. B60N 2/02; H02K 1/14; H02K 1/2706; H02K 3/34; H02K 5/22; H02K 7/08; H02K 7/116; H02K 11/33

(52) U.S. Cl. CPC B60N 2/02253; B60N 2/02258; H02K 1/145; H02K 1/2706; H02K 3/345; H02K 5/225; H02K 7/085; H02K 7/1166; H02K 11/33; H02K 2203/03; H02K 2211/03

(57) ABSTRACT

Provided are a driving motor using a brushless direct-current (BLDC) motor and a seat actuator using same, the driving motor employing the BLDC motor as a driving device such that torque control, speed control and the like may be precisely performed and noise and vibration may be reduced. The driving motor includes: a motor housing having a first chamber and a second chamber inside a container; a rotary shaft which is rotatably arranged at the center of the first chamber, and which has a first worm gear integrally formed in an extension part extending to the outside of the first chamber; a rotor having a back yoke and a ring-shaped magnet arranged on the outer circumference of the rotary shaft; a stator arranged on the outside of the rotor with an air gap therebetween, and arranged on the outer circumferential portion of the first chamber in order to rotatably drive the rotor; and a printed circuit board (PCB) which is arranged to cover the tops of the first chamber and the second chamber, and on which electronic components having a motor driving circuit for applying a driving signal to U, V, and W three-phase coils of the stator are mounted.

### TECHNICAL FIELD

The present invention relates to a seat actuator, and especially to a driving motor using a brushless direct-current (BLDC) motor that can precisely perform torque control and speed control by employing a BLDC motor as a driving device and reduce noise and vibration, and a seat actuator using the driving motor.

### BACKGROUND ART

An electric actuator rotates or linearly moves a passive object to be driven with a high torque rotational force obtained by torque conversion of the rotational force generated from a rotating power source.

In order to drive a DC motor, a BLDC motor, a step motor, etc., such motors may be controlled using a motor driver suitable for each motor type.

In order to drive the DC motors, the DC motors operate by simply providing electricity for the DC motor without a control device, but BLDC motors and the like do not operate without a motor driver.

In general, motor drivers can accurately perform torque control, speed control, voltage control, current control, position control, and the like, and motor protection functions are also possible.

Vehicle actuators mostly employ DC motors which are inexpensive and simple to control compared to BLDC motors.

Since the conventional electric actuator uses a DC motor having an external casing as a rotating power source, it is possible to only rotate at a constant speed and not to control a variable speed. In addition, in the case of a DC motor that does not use a Hall sensor, only a constant speed of forward and reverse rotational motion is possible.

The speed of the motor may be changed by controlling the DC voltage. As the voltage increases, the speed increases, and as the voltage decreases, the speed decreases. However, pulse width modulation (PWM) control is used because DC voltage is difficult to control easily.

However, in the case of a DC motor that does not use a driver, speed control by DC voltage control cannot be achieved.

In the case of using a DC motor, the brake torque should be increased by using a worm gear because a stationary position should be kept when external pressure is applied on the output shaft that rotates forward and reverse.

In general, a conventional vehicle actuator uses a DC motor as a rotating power source, and the rotor output of the DC motor is torque-converted through a gear train in which a worm gear and a plurality of spur gears which are integrally formed in a rotor output end are gear-engaged to generate a high torque rotational output from an actuator output end.

Korean Patent Application Publication No. 10-2012-0070525 (Patent Document 1) discloses an actuator for an electric adjustment device for automobile seats with multiple adjustment functions constructed using DC motors. Korean Patent Registration Publication No. 10-2187915 (Patent Document 2) discloses an electric actuator assembly using a DC motor.

Korean Patent Application Publication No. 10-2012-0030449 (Patent Document 3) discloses an actuator assembly including: a housing including first and second housing portions forming first and second cavities, respectively; a motor assembly mounted in the first cavity in the first housing portion and including a rotor shaft; a circuit board assembly positioned within the housing in an overlying relationship with the motor assembly, in which the rotor shaft extends in the second cavity through the circuit board assembly; a gear assembly positioned within the second cavity in the second housing portion in an overlying relationship with at least a portion of the circuit board assembly and the motor assembly and coupled to the rotor shaft; and an output shaft formed by the second housing portion and extending in a second cavity coupled to the gear assembly.

The actuator assembly of Patent Document 3 is not suitable for applying a rectangular housing structure to a seat actuator, and the internal structure is complex and assembly productivity is low as the motor assembly and gear assembly are divided and arranged by a large circuit board inside a single housing.

The DC motor has a cheaper price compared to the BLDC motor, but uses a commutator, to accordingly cause the DC motor to be noisy, have low torque, and have low efficiency. In addition, even when the noise generated in an electric vehicle is small, the seat actuator using a DC motor may be greatly recognized by the user.

It is difficult to implement a DC motor-driven seat actuator because precise control is required to give the vehicle seat a high-end function such as a low-noise and smooth-acting recliner.

### DISCLOSURE

### Technical Problem

It is an objective of the present invention to provide a driving motor using a brushless direct-current (BLDC) motor that can precisely perform torque control and speed control by employing a BLDC motor as a driving device and reduce noise and vibration, and a seat actuator using the driving motor.

It is another objective of the present invention to provide a driving motor using a BLDC motor that can be precisely controlled to give high-quality functions such as a low-noise, smooth-acting recliner seat, a relaxation seat, and an electric extension seat, and a seat actuator using the driving motor.

It is another objective of the present invention to provide a driving motor using a BLDC motor that facilitates assembly productivity and easy after service (A/S) and a seat actuator using the driving motor in which a reduction gear unit is assembled to a motor housing and a gear unit housing and then easily detachably coupled with each other.

It is another objective of the present invention to provide a driving motor and a seat actuator using the driving motor in which start wires of U, V, and W three-phase coils may be connected to a printed circuit board (PCB) using a press fit terminal, and end wires of the U, V, and W three-phase coils may be connected without soldering by forming a neutral point (COM) of a Y-connection method by using a mag mate wiring box.

### Technical Solution

In order to achieve the above objective, according to an aspect of the present invention, there is provided a driving motor for a seat actuator including: a motor housing having a first chamber and a second chamber interconnected with each other inside a container and divided into sections; a rotary shaft which is rotatably arranged at the center of the first chamber, and which has a first worm gear integrally formed in an extension part extending to the outside of the first chamber; a rotor having a back yoke and a ring-shaped magnet arranged on the outer circumference of the rotary shaft; a stator arranged on the outside of the rotor with an air gap therebetween, and arranged on the outer circumferential portion of the first chamber in order to rotatably drive the rotor by generating a rotating magnetic field; and a printed circuit board (PCB) which is arranged to cover the tops of the first chamber and the second chamber, and on which a plurality of electronic components having a motor driving circuit for applying a driving signal to U, V, and W three-phase coils of the stator are mounted.

The driving motor for the seat actuator may further include a plurality of Hall sensors each mounted on a lower surface of the PCB and configured to be positioned close to a portion where the magnet of the rotor is located, and the driving motor may be a BLDC motor driven by a 6-step full-wave driving method using an inverter of the motor driving circuit after receiving a rotor position signal from the plurality of Hall sensors.

When the U, V, and W three-phase coils of the stator are wound around a plurality of teeth, and the each phase coils are connected in series, a start wire of each of the U, V, and W three-phase coils may be press-fitted and coupled to the PCB using a press fit terminal.

In addition, an end wire of each of the U, V, and W three-phase coils may form a Y-connection neutral point (COM) using a mag mate wiring box.

The driving motor for a seat actuator according to the present invention may further include a connector installed in the second chamber of the motor housing and connected to the PCB through a plurality of terminals to communicate with a control system of the vehicle, wherein the plurality of terminals may include power supply voltage Vcc, ground voltage GND, and local interconnect network (LIN) communication line.

The stator includes: a stator core including a plurality of teeth each having a T-shaped front end portion extending in an axial direction and a back yoke connected to the plurality of teeth to form a magnetic circuit; upper and lower insulators surrounding a coil winding region of each of the plurality of teeth by half in upper and lower portions thereof; and a coil wound around an outer circumferential surface of each of the upper and lower insulators, wherein each of the upper and lower insulators may include: an annular base frame having a predetermined width; and a plurality of teeth accommodating portions protruding from the base frame and receiving the winding regions of the teeth from the upper portion and the lower portion by half.

In this case, a connector housing is integrally formed in the motor housing forming the second chamber, and is connected to the PCB through a plurality of terminals integrally formed in the connector housing to communicate with a control system of the vehicle.

The driving motor for a seat actuator according to the present invention further includes: a bearing that rotatably supports a lower end portion of the rotary shaft; a protrusion having a two-stage structure groove formed in the lower portion of the first chamber of the motor housing for accommodating the bearing and the lower end portion of the rotary shaft; and a stopper having one side inserted into a stopper insertion groove arranged around the groove to prevent the bearing and the rotary shaft from being separated, wherein a front end portion of the stopper may be coupled to a separation preventing groove formed in a ring shape at the lower end portion of the rotary shaft.

According to another embodiment of the present invention, the seat actuator includes: a motor housing having a first chamber and a second chamber interconnected with each other inside a container and divided into sections; a gear housing having a cylindrical third chamber assembled to the upper portion of the motor housing and interconnected to each other inside a container and divided into sections, and a cylindrical fourth chamber orthogonal to the cylinder of the third chamber and arranged on the same axis as the first chamber; rear and front covers respectively coupled to the rear and front of the gear housing; an inner rotor type driving motor arranged in the first chamber of the motor housing and having a first worm gear integrally formed in an extension part extending from the first chamber to the fourth chamber; and a reduction gear unit accommodated in the third chamber and having a worm wheel gear coupled to an outer circumference of the first worm gear to generate a deceleration output in a hollow shaft installed at the center thereof, wherein the deceleration output of the reduction gear unit linearly moves a movable bracket screw-coupled to a lead screw having one end coupled to the hollow shaft forward or backward.

In this case, the reduction gear unit may include: a gear housing having a cylindrical third chamber interconnected to each other inside the container and divided into sections, and a cylindrical fourth chamber orthogonal to the cylinder of the third chamber and arranged on the same axis as that of the first chamber; a worm wheel gear accommodated in the third chamber, having a hollow shaft installed in a central portion thereof, and having an outer circumferential portion gear-coupled to an outer circumference of the first worm gear to generate a deceleration output; a rear cover coupled to the rear of the third chamber and rotatably supporting one end of the hollow shaft; a front cover coupled to the front of the third chamber and having a through hole formed in the center thereof; a bearing installed in the third chamber to rotatably support the other end of the hollow shaft; and a lead screw having one end coupled to the hollow shaft of the worm wheel gear through the through hole of the front cover, and configured to linearly move forward or backward the movable bracket screw-coupled to a screw portion while rotating in conjunction with the rotation of the worm wheel gear.

The movable bracket may be connected to one of a legrest, a seat cushion, and a seatback in which movable operation is performed in a seat for a vehicle.

The motor housing and the gear housing may be detachably coupled to each other.

In addition, an upper housing coupled to an upper portion of the motor housing may be integrally formed under the gear housing.

Further, the seat actuator may further include a pair of protrusions protruding from both ends of one side surface of the gear housing to form an accommodation groove for accommodating an upper portion of the connector of the driving motor.

### Advantageous Effects

As described above, by employing the BLDC motor as a driving device of the present invention, torque control, speed control, etc. may be precisely performed and noise and vibration may be reduced.

As a result, in the present invention, it is possible to precisely control the vehicle seat to give high-quality functions such as a low-noise and smooth-acting recliner seat, a relaxation seat, and an electric extension seat.

In addition, in the present invention, the driving motor and the reduction gear unit are assembled to the motor housing and the gear housing, respectively, and then easily detachably coupled to each other, thereby facilitating assembly productivity and after-service (A/S).

Further, in the present invention, start wires of U, V, and W three-phase coils may be connected to a printed circuit board (PCB) using a press fit terminal, and end wires of the U, V, and W three-phase coils may be connected without soldering by forming a neutral point (COM) of a Y-connection method by using a mag mate wiring box.

When the U, V, and W three-phase coils of the stator are wound around a plurality of teeth, and the each phase coils are connected in series, the start wire of each of the U, V, and W three-phase coils may be press-fitted and coupled to the PCB using a press fit terminal.

In addition, each end wire of the U, V, and W three-phase coils may form a Y-connection neutral point (COM) using a mag mate wiring box.

Moreover, in the present invention, the number of components and the number of assembly operations may be reduced by integrally forming the connector in the motor housing.

The seat actuator of the present invention may increase efficiency and torque by employing a BLDC motor as a driving device.

In addition, noise and vibration generation may be improved in the present invention by forming an “R” in the shape of the tip of the stator core (teeth) to obtain back electromotive force (EMF) waveform in the form of a sine curve.

### BRIEF DESCRIPTION OF THE DRAWINGS

FIG. 1 is a perspective view illustrating a support frame of a vehicle seat to which a seat actuator according to the present invention is applied.

FIGS. 2A to 2E are a perspective view, a plan view, and cross-sectional views taken along line A-A to line C-C of FIG. 2B, respectively, illustrating a seat actuator according to a first embodiment of the present invention.

FIGS. 3A and 3B are a partial exploded perspective view illustrating a separation of the driving motor and the reduction gear unit in the seat actuator according to the first embodiment of the present invention, and a whole exploded perspective view illustrating a completely disassembled reduction gear unit, respectively.

FIGS. 4 and 5 are a front view showing the driving motor according to the first embodiment of the present invention and a cross-sectional view taken along line D-D of FIG. 4, respectively.

FIG. 6 is a plan view illustrating the driving motor according to the first embodiment of the present invention.

FIGS. 7 and 8 are cross-sectional views taken along line E-E and line F-F of FIG. 6, respectively.

FIG. 9 is an exploded perspective view illustrating the driving motor according to the first embodiment of the present invention.

FIG. 10 is a front view illustrating a driving motor according to a second embodiment of the present invention.

FIG. 11 is a cross-sectional view taken along line G-G of FIG. 10.

FIG. 12 is a plan view illustrating the driving motor according to the second embodiment of the present invention.

FIG. 13 is a cross-sectional view taken along line H-H of FIG. 13.

FIG. 14 is a schematic view illustrating an installation position of a Hall sensor according to the first embodiment of the present invention.

FIG. 15 is a perspective view illustrating a seat actuator according to the second embodiment of the present invention.

FIGS. 16A and 16B are a perspective view illustrating a separation of the driving motor and the reduction gear unit in the seat actuator according to the second embodiment of the present invention, and an exploded perspective view illustrating a disassembled reduction gear unit, respectively.

FIGS. 17 and 18 are a perspective view and a front view, respectively, illustrating a driving motor used in the seat actuator according to the second embodiment of the present invention.

FIG. 19 is a plan view illustrating the driving motor used in the seat actuator according to the second embodiment of the present invention.

FIGS. 20 to 22 are cross-sectional views taken along lines I-I, J-J, and K-K of FIG. 18, respectively.

FIGS. 23 and 24 are cross-sectional views taken along line L-L and line M-M of FIG. 19, respectively.

FIG. 25 is an exploded perspective view illustrating the driving motor used in the seat actuator according to the second embodiment of the present invention.

FIG. 26 is a schematic view illustrating an installation position of a Hall sensor according to the second embodiment of the present invention.

FIG. 27 is a circuit diagram of an equivalent circuit of a stator coil and an inverter circuit of a motor driving circuit according to an embodiment of the present invention.

### BEST MODE FOR CARRYING OUT THE INVENTION

Hereinafter, embodiments of the present invention will be described in detail with reference to the accompanying drawings.

The sizes and shapes of the components shown in the drawings may be exaggerated for clarity and convenience. In addition, terms defined in consideration of the configuration and operation of the present invention may vary depending on the intention or custom of the user, the operator, and the like. Definitions of these terms should be based on the content of this specification.

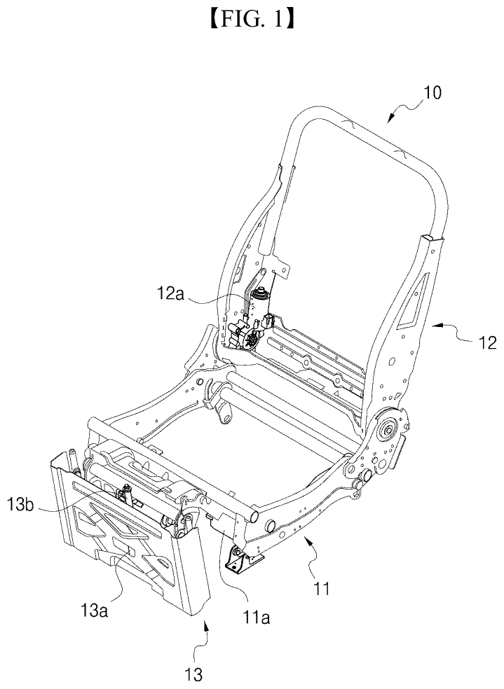

FIG. 1 is a perspective view illustrating a support frame of a vehicle seat to which a seat actuator according to the present invention is applied.

Referring to FIG. 1, a support frame 10 of a vehicle seat is installed at the rear of a seat cushion frame 11 so that a seatback frame 12 may be tilted forward or backward, and a legrest frame 13 may be vertically tilted in front of the seat cushion frame 11. In addition, a lower portion of the seat cushion frame 11 is slidably installed in the front-rear direction on a seat rail.

The vehicle seat may include first and second legrest actuators 13a and 13b for driving the legrest frame 13 to be tilted up and down in front of the seat cushion frame 11, a recliner actuator 12a for driving the seatback frame 12 to be tiltable forward or backward at the rear of the seat cushion frame 11, a relaxation actuator 11a for tilting the seatback frame 12 and the legrest frame 13 together with the seat cushion frame 11 by a desired angle to induce a relaxed state to the user.

As described above, the vehicle seat employs a plurality of seat actuators to individually control the legrest or the seatback or to execute a relaxation mode or a recliner mode for simultaneously operating the legrest, the seat cushion, and the seatback.

The seat actuator of the present invention may be applied to the legrest actuators 13a and 13b, the recliner actuator 12a, and the relaxation actuator 11a, which are applied to the vehicle seat.

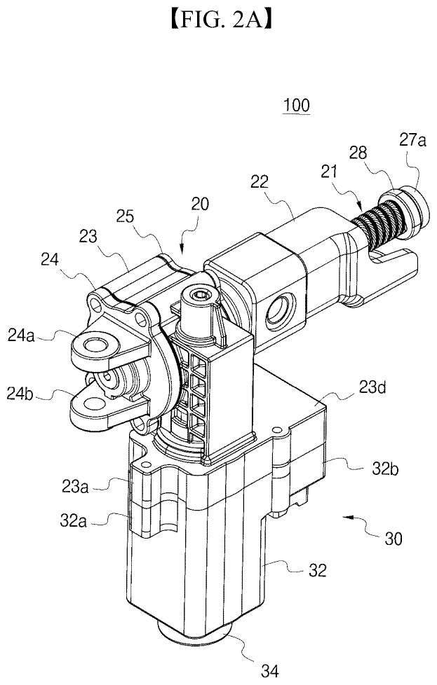

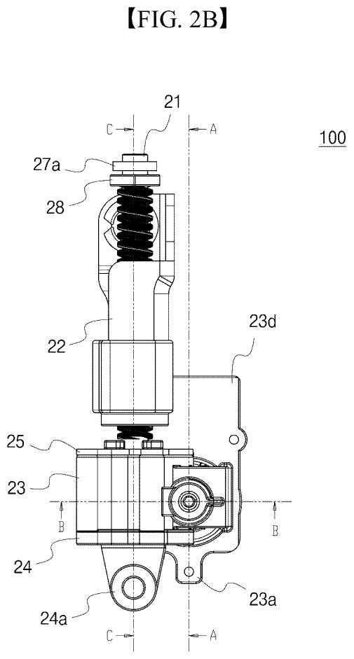

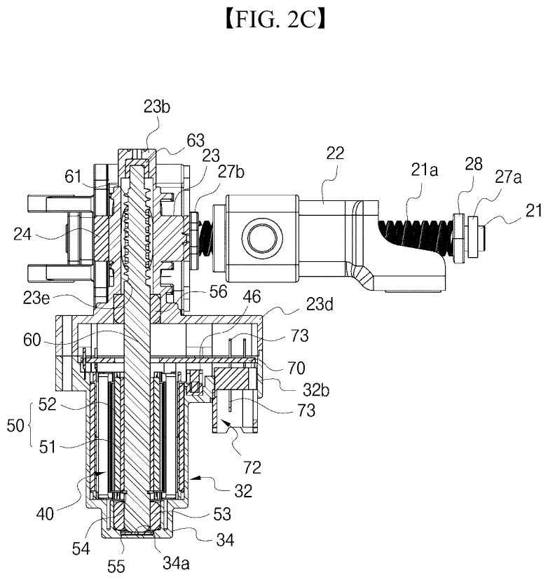

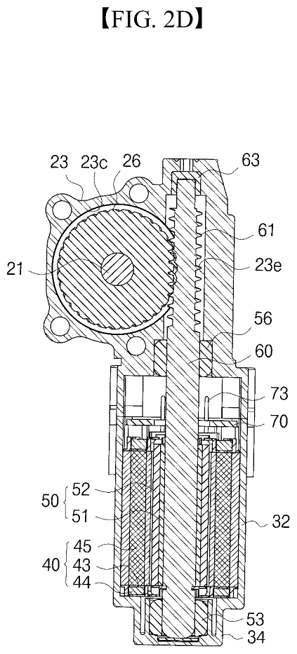

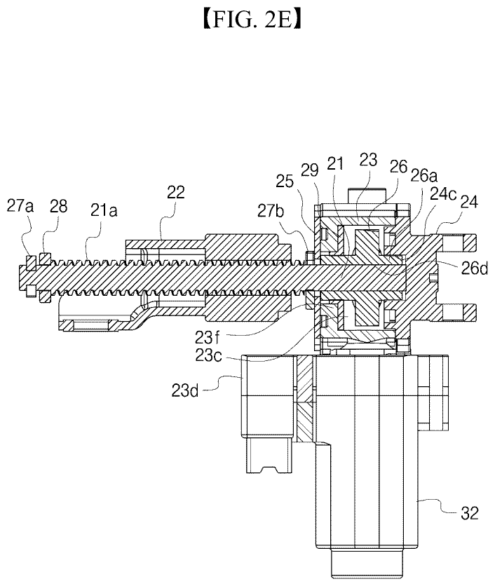

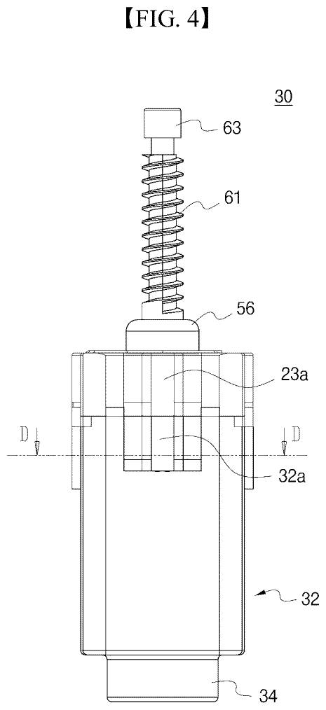

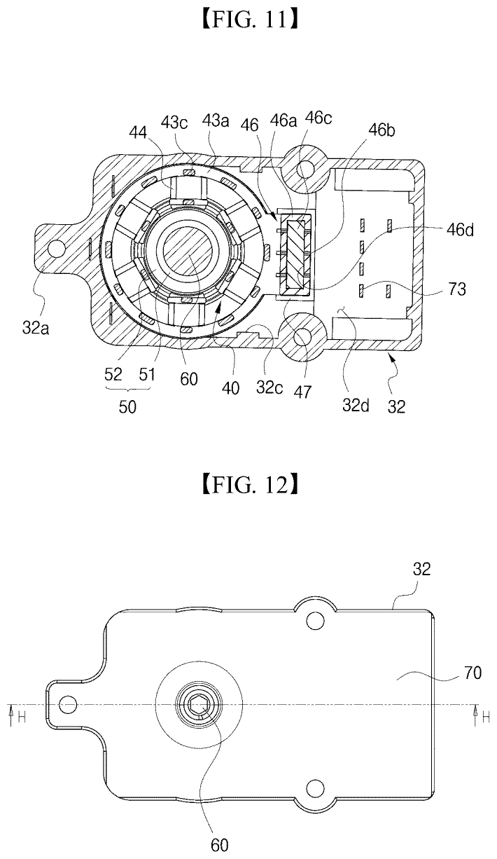

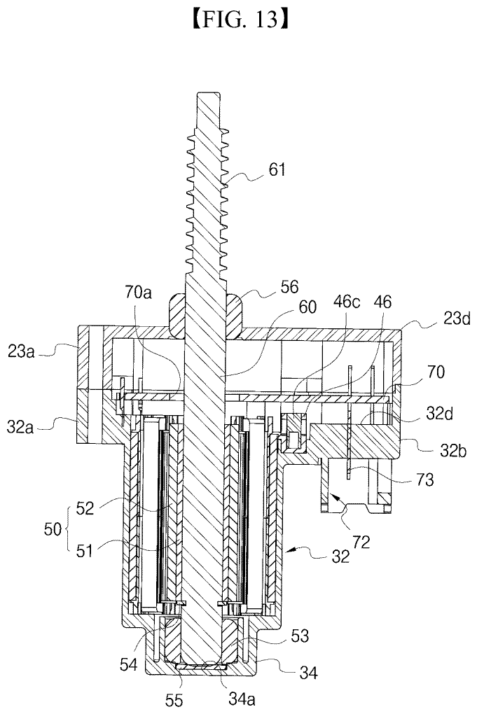

Referring to FIGS. 2A to 15, the seat actuator 100 according to the first embodiment of the present invention includes a driving motor 30 and a reduction gear unit 20, which are detachably coupled to each other.

In the following description, an upper housing 23d coupled to an upper portion of a motor housing 32 is integrally formed under a gear housing 23. For convenience of description, the upper housing 23d may be shown separately from the gear housing 23.

First, the driving motor 30 according to the first embodiment employed in the seat actuator 100 according to the first embodiment of the present invention is described with reference to FIGS. 2 to 9.

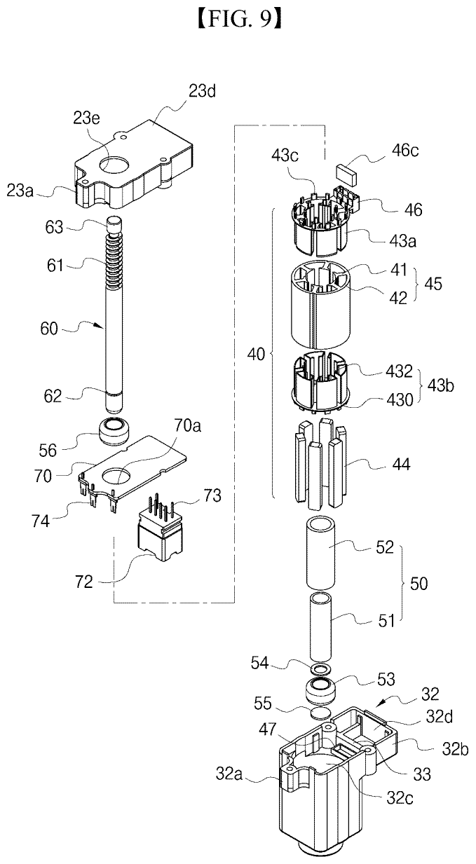

As shown in FIG. 9, the driving motor 30 is implemented in an inner rotor type in which the rotor 50 is arranged inside the stator 40, and includes a motor housing 32, a rotary shaft 60, a rotor 50, a stator 40, a printed circuit board (PCB) 70 on which electronic components having a motor driving circuit are mounted, and a connector 72.

The motor housing 32 has a rectangular cylindrical shape, and includes a first chamber 32c having a circular cross-section and a second chamber 32d having a substantially rectangular shape, and the first chamber 32c and the second chamber 32d are separated from each other by a partition 33.

The rotary shaft 60, the rotor 50, and the stator 40 constituting a motor are arranged in the first chamber 32c, the connector 72 is arranged in the second chamber 32d, and the PCB 70 having a rectangular shape is arranged on the first chamber 32c and the second chamber 32d.

Since only the connector 72 is arranged inside the second chamber 32d, only the upper portion of the rectangular container forming the first chamber 32c is extended to form a connector accommodating portion 32b.

In addition, a plurality of coupling portions 32a, for example, three coupling portions 32a, are arranged at intervals outside the motor housing 32 so as to be detachably coupled to the gear housing 23 of the reduction gear unit 20, and a through hole capable of fastening a fixing screw or a fixing bolt/fixing nut is formed in the center of each of the three coupling portions 32a.

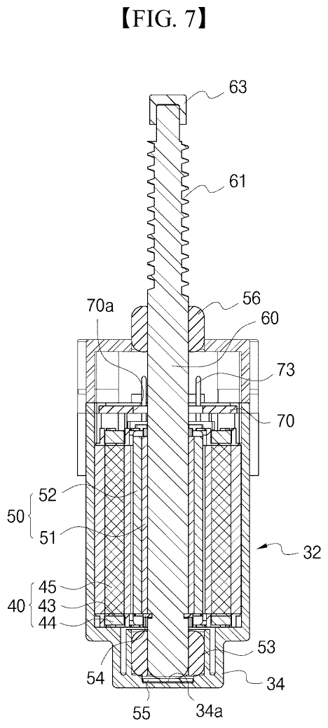

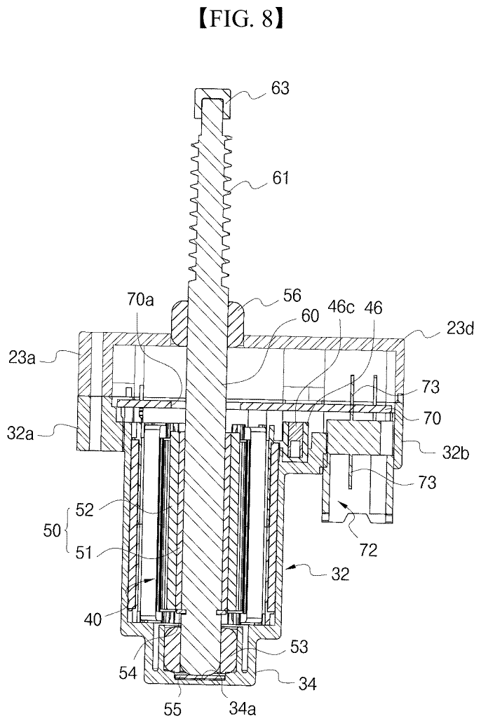

Moreover, as shown in FIGS. 7 and 8, a protrusion 34 having a two-stage concave groove 34a provided therein to accommodate a lower bearing 53 and the lower end portion of the rotary shaft 60 is formed in the lower portion of the first chamber 32c of the motor housing 32.

In addition, a support plate 55 for reducing the rotational resistance of the lower end of the rotary shaft 60 is inserted into the bottom of a first end of the concave groove 34a, and the lower bearing 53 is inserted into a second end of the concave groove 34a.

A separation prevention groove 62 is formed in a ring shape at a lower end portion of the rotary shaft 60, and a stopper 54 is coupled to the separation prevention groove 62.

A lower portion of the rotary shaft 60 is rotatably supported by the lower bearing 53, and an upper portion of the rotary shaft 60 is rotatably supported by an upper bearing 56 embedded in a gear housing 23 to be described later.

In addition, the rotary shaft 60 extends upward from the motor housing 32 so as to transfer the rotational output of the rotor 50, and a worm gear 61 is integrally formed at an upper portion of the rotary shaft 60 located inside the gear housing 23.

The rotor 50 is provided with a cylindrical back yoke 51 outside the rotary shaft 60, and a cylindrical magnet 52 is arranged outside the back yoke 51. The magnet 52 may employ a magnet in which an N-pole and an S-pole are split into a multi-pole in a ring-shaped magnet or split magnet segments of a plurality of N-poles and S-poles, and the back yoke 51 is installed on the rear surface of the magnet 52 to form a magnetic circuit.

The stator 40 includes: a stator core 45 having a plurality of teeth 41 each having a “T” shape and an annular back yoke 42 interconnected with the plurality of teeth 41 to form a magnetic circuit; upper and lower insulators 43a and 43b made of an insulating material and coupled to an upper portion and a lower portion of each of the plurality of teeth 41, except for an exposed surface of each of the plurality of teeth 41 facing the magnet 52, so as to surround, by half, the outer circumferential surface to which a coil 44 is wound; and the coil 44 wound around the outer circumferential surfaces of the upper and lower insulators 43a and 43b.

Each of the upper and lower insulators 43a and 43b includes: an annular base frame 430 having a predetermined width; and a plurality of teeth accommodating portions 432 protruding from the base frame and receiving the winding regions of the teeth from the upper portion and the lower portion by half.

In addition, the upper and lower insulators 43a and 43b may include a bobbin made of an insulating material integrally formed to surround an outer circumferential surface around which the coil 44 of each of the plurality of teeth 41 is wound.

The driving motor 30 of the present invention is a radial gap type motor, and the plurality of teeth 41 of the stator core 45 and the magnet 52 of the rotor 50 face each other through an air gap.

An exposed surface of a shoe of the tooth 41 facing the magnet 52 of the rotor 50 may have a “rounded (R)” shape. In this case, noise and vibration generation may be improved in the driving motor 30 of the present invention by forming an “R” in the shape of the tip of the stator core (teeth) to obtain back electromotive force (EMF) waveform in the form of a sine curve.

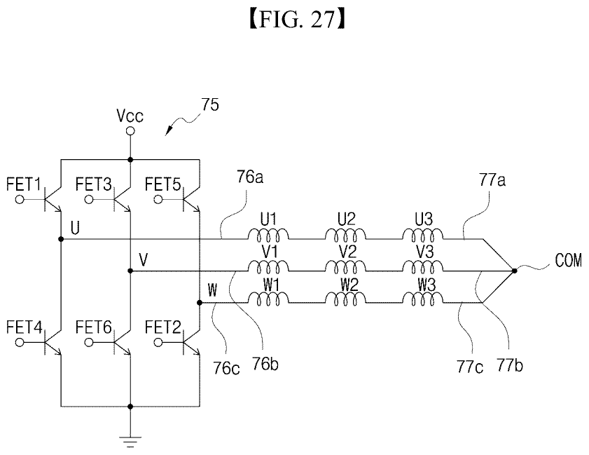

In this case, as shown in FIG. 27, when the three coils 44 are wound around the upper and lower insulators 43a and 43b for each phase such that a BLDC motor is driven in a U, V, and W three-phase driving manner as a stator support role, a plurality of protrusions 43c used to interconnect the start wires 76a to 78c and the end wires 77a to 77c of the U, V, and W three-phase coils (U1 to U3, V1 to V3, and W1 to W3) 44 may protrude in the upper and lower insulators 43a and 43b.

The seat actuator 100 according to the present invention may include the driving motor 30, for example, a BLDC motor having a 12 pole-9 slot or 8 pole-6 slot structure. The embodiment illustrated in the drawing illustrates a BLDC motor having a 12 pole-9 slot structure.

Further, in the driving motor 30, the coil 44 of the stator 40 has a U, V, and W three-phase structure. When a circuit is configured by winding coils around the nine teeth 41, the three-phase coils U1 to U3, V1 to V3, and W1 to W3 wound around the three teeth 41 for each phase of U, V, and W may be connected in series, and the three-phase driving circuit wired in a Y-connection manner may be represented as shown in FIG. 27.

FIG. 27 is a circuit diagram of an equivalent circuit of a stator coil 44 and an inverter circuit 75 of a motor driving circuit according to an embodiment of the present invention.

The arrangement of the nine coils U1 to U3, V1 to V3, and W1 to W3 wound around the nine teeth 41 is formed by winding the coils U1 to U3, V1 to V3, and W1 to W3 so that the coils U1 to U3, V1 to V3, and W1 to W3 are alternately arranged for each phase of U, V, and W, assembling a start wire 76a of the front end portion U1 of the U-phase coils U1 to U3, a start wire 76b of the front end portion V1 of the V-phase coils V1 to V3, and a start wire 76c of the front end portion W1 of the W-phase coils W1 to W3 to press fit terminals 74 that do not require soldering, respectively, and pressing the three press fit terminals 74 to be directly connected to the U-phase, V-phase, and W-phase output terminals of an inverter circuit 75 mounted on the PCB 70.

As shown in FIGS. 6 and 9, the PCB 70 has a rectangular shape, is assembled to cover an upper portion of the motor housing 32, and has one side assembled with the press fit terminals 74 connected to three stars wires 76a to 76c.

A through hole 70a is formed at one side of the PCB 70 to allow the extension of the rotary shaft 60 to pass therethrough, and the other side of the PCB 70 is connected to six terminals 73 provided in the connector 72.

In general, in order to interconnect a stator coil of a driving motor and a printed circuit board (PCB) on which a motor driving circuit is mounted, when connecting the coil with the PCB by using terminals, soldering is performed to promote an electrical connection.

As a method of connecting the coils without any soldering, the coils are press-fitted into the PCB 70 by using the press fit terminals 74 without soldering. Each of the press fit terminals 74 press-fitted into the PCB 70 is a pin which is inserted while reducing the inner side due to the thin body thickness of the contractible coupling portion located at the lower end thereof, and is used for interconnection without soldering, while, when the terminal is fully inserted into the PCB, the upper end thereof is unfolded again by tension.

A general press fit terminal product has an inner hole and is press-fitted into a PCB hole by tension. However, the press fit terminal with an inner hole has a disadvantage in which a mold structure is complicated and a unit price of the product is high. Alternatively, in the present invention, the stator 40 and the PCB 70 may be connected using a low-cost press-fit terminal 74 without an inner hole.

In addition, as shown in the equivalent circuit of the stator coil 44 shown in FIG. 27, the end wires 77a to 77c of the three-phase coils U1 to U3, V1 to V3, and W1 to W3 may be made using a mag mate connectivity which does not require soldering to form a Y-connection neutral point (COM).

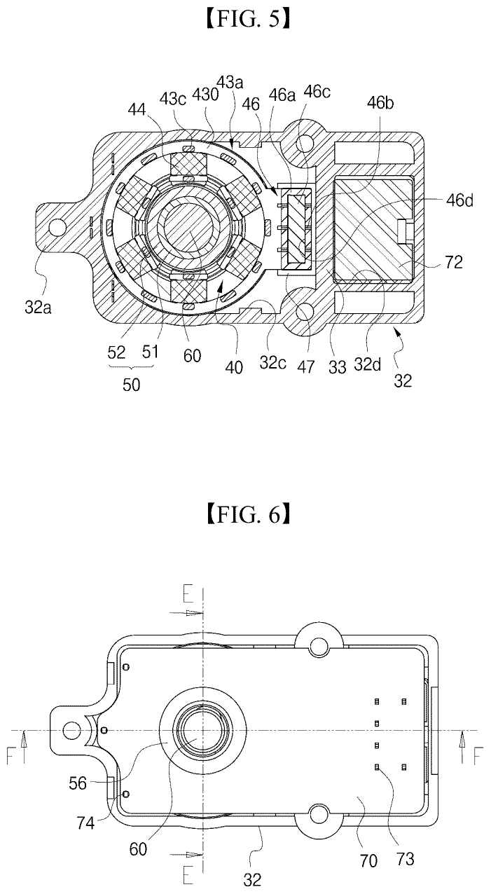

To this end, as shown in FIG. 5, the end wires 77a to 77c of the end portions U3, V3, and W3 of the respective phase coils U1 to U3, V1 to V3, and W1 to W3 are connected to each other using a mag mate wiring box 46 having three insertion slots 46b. The mag mate wiring box 46 may be integrally formed with the base frame 430 of the upper insulator 43a, and include a rectangular wiring box housing 46a having three insertion slots 46b and a tri-slot terminal 46c inserted into an accommodation groove 46d inside the wiring box housing 46a to interconnect the end wires 77a to 77c inserted into the three insertion slots 46b.

The mag mate wiring box 46 is inserted into and fixed to a mag mate accommodating portion 47 arranged adjacent to a partition wall 33 separating the first chamber 32c and the second chamber 32d from each other.

When the end wires 77a to 77c of the three-phase coils U1 to U3, V1 to V3, and W1 to W3 are configured to form a Y-connection neutral point (COM), the three end wires 77a to 77c are respectively inserted into the three insertion slots 46b of the mag mate wiring box 46, and then, when the tri-slot terminal 46c is inserted into the inner receiving groove 46d of the wiring box housing 46a, the common connection of the three end wires 77a to 77c is achieved.

The connector 72 includes six terminals 73, and communication may be performed between a motor driving circuit mounted on the PCB 70 and a control system of a vehicle located outside. The six terminals 73 may include, for example, Vcc, GND, a LIN communication line, and three reserved terminals. In this case, as shown in FIG. 8, the connector 72 may be detachably assembled to the second chamber 32d of the motor housing 32 together with the PCB 70 after the electrical connection is made using the terminal 73 on the lower surface of the PCB 70.

Furthermore, for example, the driving motor 30 may receive a rotor position signal from two or three Hall sensors 71 in the motor driving circuit implemented in the PCB 70, and may be driven by a 6-step full-wave driving method using an inverter circuit 75.

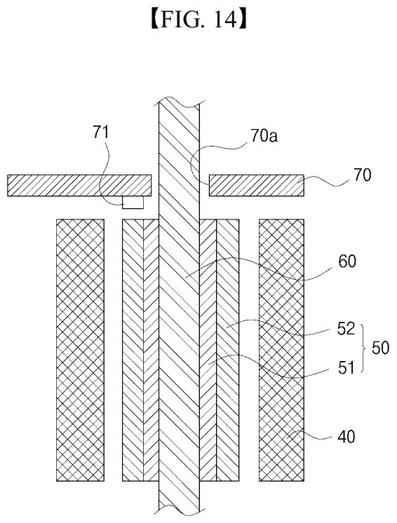

In the driving motor 30 according to the present invention, as shown in FIG. 14, a surface mount device (SMD)-type Hall sensor 71 is mounted on the lower surface of the PCB 70. In this case, the Hall sensor 71 is arranged on the lower surface of the PCB 70 so that the position of the Hall sensor 71 is set to be close to a portion where the magnet 52 of the rotor 50 is located.

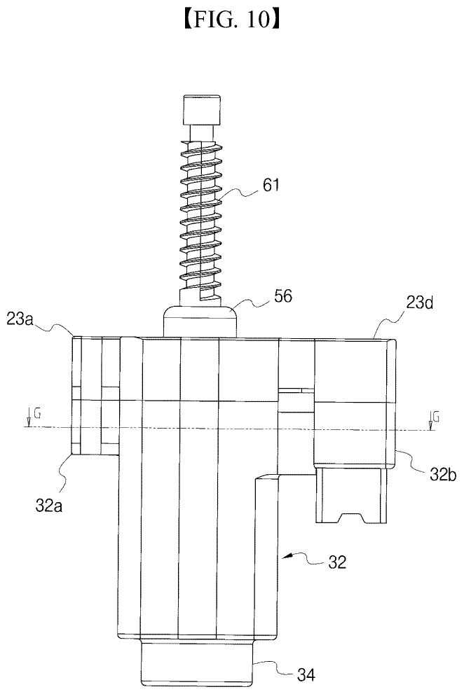

Hereinafter, a driving motor 30 according to a second embodiment of the present invention is described with reference to FIGS. 10 to 14.

The driving motor 30 is implemented in an inner rotor type in which a rotor 50 is arranged inside a stator 40, and includes a motor housing 32, a rotary shaft 60, a rotor 50, a stator 40, a printed circuit board (PCB) 70 on which electronic components having a motor driving circuit are mounted, and a connector 72.

The driving motor 30 according to the second embodiment of the present invention is substantially the same as the first embodiment except for the connector 72.

In the first embodiment, after the connector 72 is electrically connected to the lower surface of the PCB 70 using six terminals 73, the connector 72 is detachably assembled to the second chamber 32d of the motor housing 32 together with the PCB 70.

In the second embodiment, there is a difference from the first embodiment in that the housing of the connector 72 is integrally formed with the connector accommodating portion 32b of the motor housing 32.

The lower end portions of the six terminals 73 including Vcc, GND, the LIN communication line, and three reserved terminals are formed integrally with the connector accommodating portion 32b of the motor housing 32, and then the upper end portions thereof are assembled to the PCB 70 assembled on the upper portion of the motor housing 32 to perform electrical/physical wiring.

Since the remaining parts except for the connector 72 in the second embodiment are the same as those of the first embodiment, the same reference numerals are assigned to the remaining parts, and a detailed description thereof is omitted.

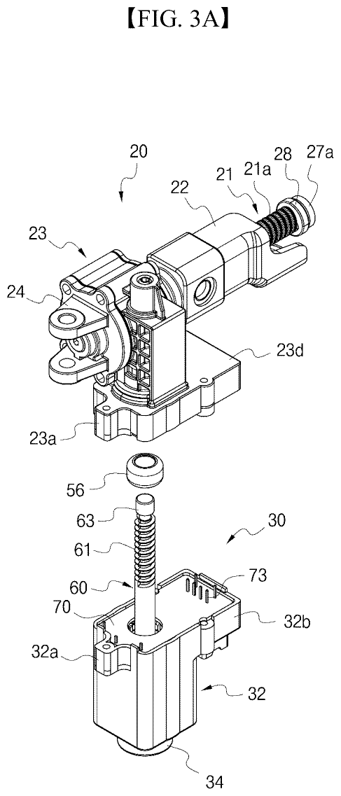

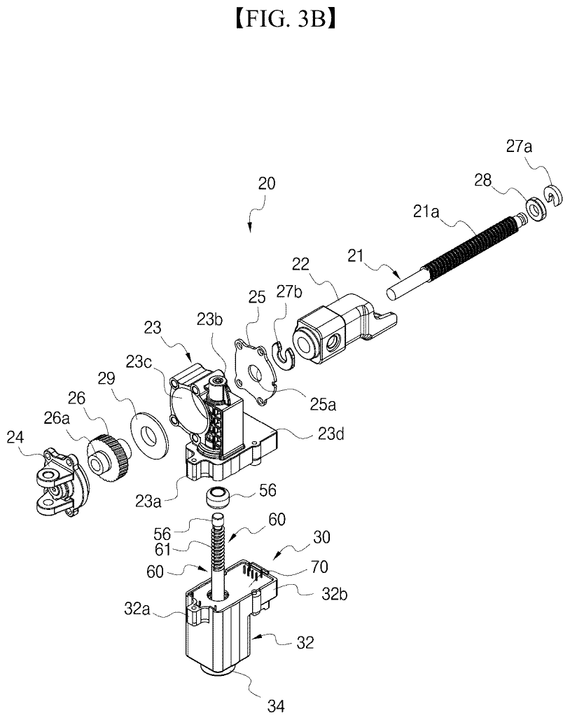

FIGS. 2A to 2E are a perspective view, a plan view, and cross-sectional views taken along line A-A to line C-C of FIG. 2B, respectively, illustrating a seat actuator according to a first embodiment of the present invention. FIGS. 3A and 3B are a perspective view illustrating a separation of the driving motor and the reduction gear unit in the seat actuator according to the first embodiment of the present invention, and an exploded perspective view illustrating a disassembled reduction gear unit, respectively.

Referring to FIGS. 2A to 3B, the reduction gear unit 20 according to the first embodiment of the present invention includes a gear housing 23, a worm wheel gear 26, a rear cover 24, a front cover 25, a lead screw 21, and a movable bracket 22.

The gear housing 23 has a horizontal cylindrical third chamber 23c for accommodating the worm wheel gear 26 therein and a vertical cylindrical fourth chamber 23e for accommodating the worm gear 61 extending from the rotary shaft 60 of the driving motor 30.

The front cover 25 and the rear cover 24 are coupled to front and rear sides of the third chamber 23c, respectively, and a fourth chamber 23e communicating with the third chamber 23c is arranged above the first chamber 32c of the motor housing 32 to communicate with each other.

A hollow shaft 26a having a hollow portion 26b is integrally formed at the center of the worm wheel gear 26, and a rear end portion of the hollow shaft 26a is inserted into a circular receiving groove 24c formed in the rear cover 24 and is rotatably supported.

The gear housing 23 is provided with a stepped portion 23f at a front inner circumferential portion of the third chamber 23c, and a through hole is formed in the center of the gear housing 23. A sleeve bearing 29 is coupled to the through hole and the stepped portion 23f, and a front end portion of the hollow shaft 26a is rotatably supported in a through hole of the sleeve bearing 29.

The front cover 25 is coupled to the front side of the gear housing 23 to prevent the hollow shaft 26a from deviating from the inside of the third chamber 23c. A through hole 25a through which one end of the lead screw 21 passes is provided at the center of the front cover 25.

In addition, a rear end portion of the lead screw 21 is coupled to the hollow shaft 26a of the worm wheel gear 26 through the through hole 25a formed at the center of the front cover 25, a screw portion 21a is arranged in front of the lead screw 21, and a snap ring 27a and a stopper ring 28 required to support the lead screw 21 are coupled to the front end portion of the screw portion 21a. A snap ring 27b is coupled between the rear end portion of the screw portion 21a and the front cover 25 to prevent the snap ring 27b from moving rearward of the lead screw 21.

The movable bracket 22 having a female thread formed therein is installed in the screw portion 21a of the lead screw 21, and moves forward or backward according to the forward or reverse rotation of the lead screw 21.

The fourth chamber 23e of the gear housing 23 has a cylindrical inner circumferential portion oriented in a vertical direction to receive the worm gear 61 extending from the rotary shaft 60 of the driving motor 30, and a shaft accommodating portion 63 for rotatably accommodating the front end portion of the rotary shaft 60 is installed at the uppermost portion of the cylindrical inner circumferential portion.

The rotary shaft 60 of the driving motor 30 is arranged in a vertical direction, and the hollow shaft 26a and the lead screw 21 of the worm wheel gear 26 are arranged in a horizontal direction and are arranged to be perpendicular to each other.

An upper cover 23d covering an upper portion of the motor housing 32 extends in a rectangular shape at a lower side of the fourth chamber 23e, and an upper bearing 56 is installed in a communicating portion communicating with each other while being arranged above the first chamber 32c of the motor housing 32 to rotatably support the rotary shaft 60 of the driving motor 30.

A space in which electronic components mounted on the upper surface of the PCB 70 may be positioned is secured between the PCB 70 and the upper cover 23d of the motor housing 32.

In the seat actuator 100 according to the first embodiment of the present invention, when the rotor 50 and the rotary shaft 60 are rotated at a preset round per minute (RPM) according to the operation of the driving motor 30, the worm gear 61 formed in the extension part of the rotary shaft 60 also rotates.

When the worm gear 61 rotates, the worm wheel gear 26, which is gear-coupled to the worm gear 61, also rotates while decelerating, and the lead screw 21 also decelerates. As the torque increases according to the deceleration rotation of the worm wheel gear 26 and the lead screw 21, the movable bracket 22 coupled to the screw portion 21a of the lead screw 21 moves forward or backward along the screw portion 21a.

In this case, the screw portion 21a and the movable bracket 22 may be configured as a ball screw and a ball nut for a small backlash and a linear motion.

When the seat actuator 100 according to the first embodiment of the present invention is used for the legrest actuators 13a and 13b, the recliner actuator 12a, and the relaxation actuator 11a applied to the vehicle seat, one of the legrest, the seat cushion, and the seatback in which the movable bracket 22 is operated is installed or connected to perform a linear motion or a rotational motion.

Meanwhile, three coupling portions 23a respectively corresponding to three coupling portions 32a of the motor housing 32 are spaced apart from each other so that the upper cover 23d of the gear housing 23 may be coupled to the upper portion of the motor housing 32, and the three coupling portions 23a have through holes formed at the respective centers thereof to fasten fixing screws or fixing bolts/fixing nuts.

Further, a pair of protrusions 24a and 24b protrude from the rear of the rear cover 24, and a through hole is formed at the center of each of the pair of protrusions 24a and 24b, and may be used when the seat actuator 100 is fixed to a main body in which the seat actuator 100 is used.

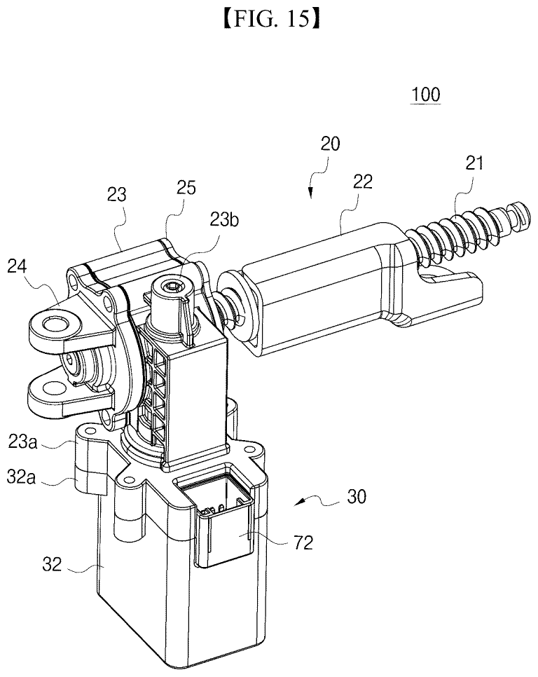

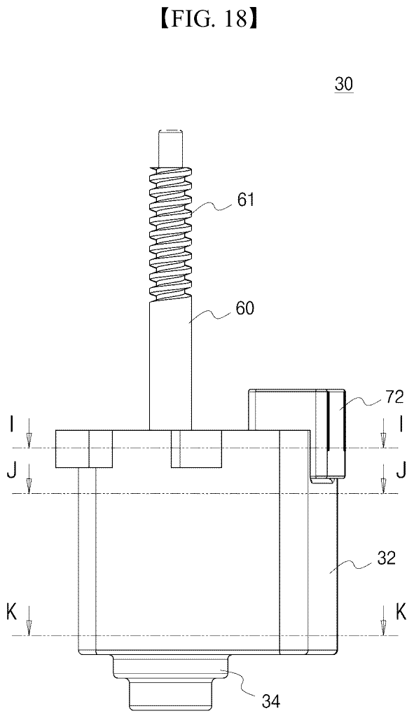

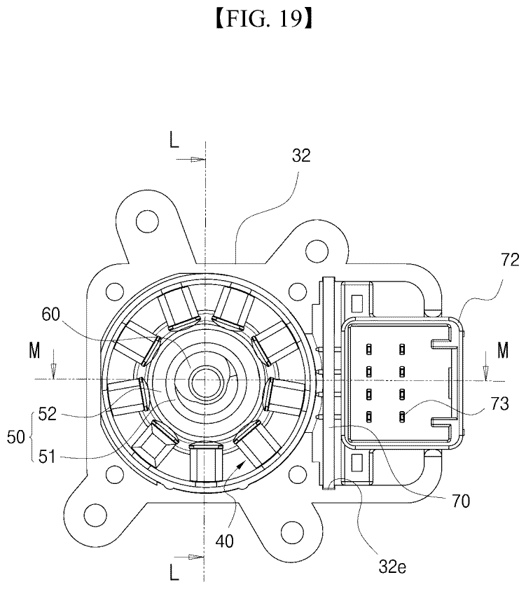

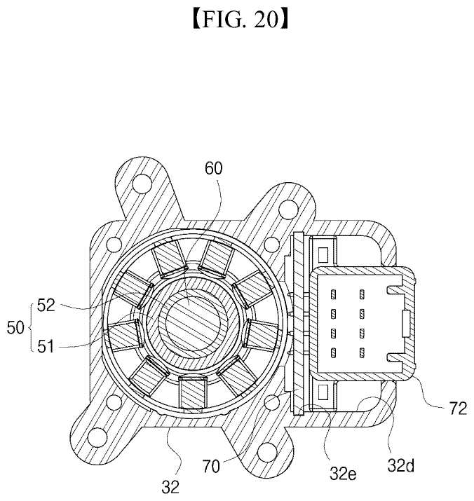

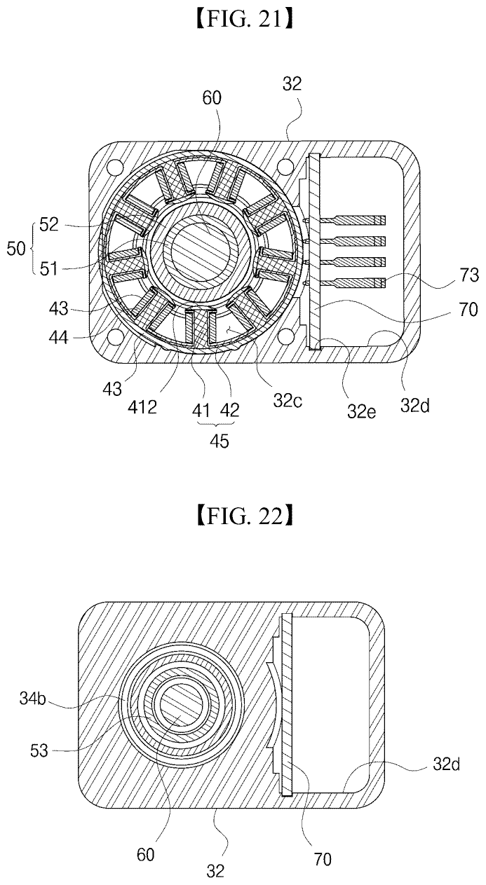

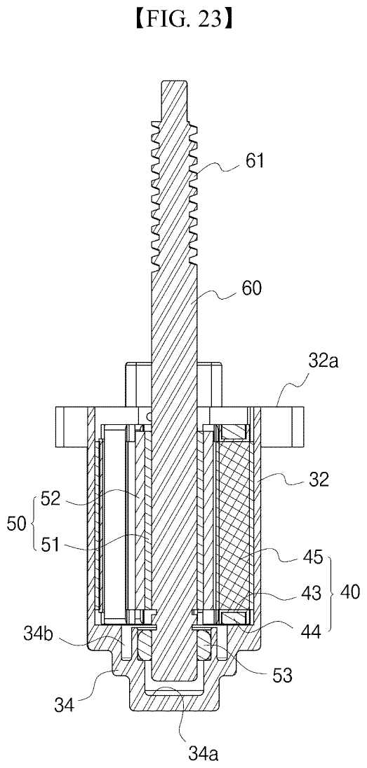

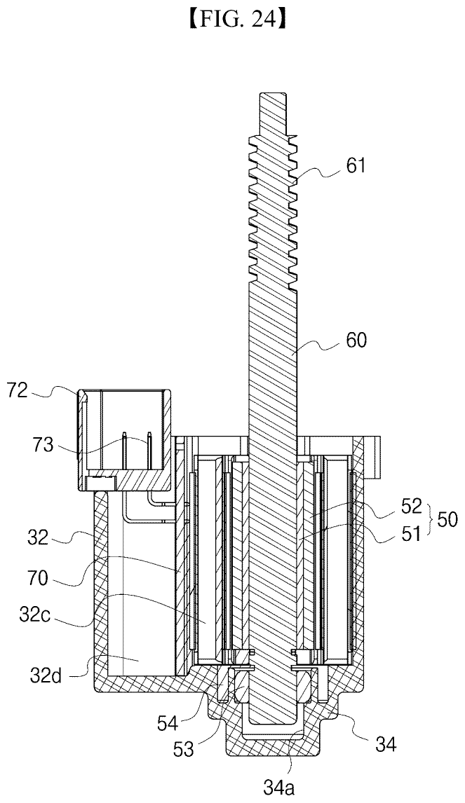

Referring to FIGS. 15 to 27, a seat actuator 100 according to the second embodiment of the present invention includes a driving motor 30 and a reduction gear unit 20, which are detachably coupled to each other.

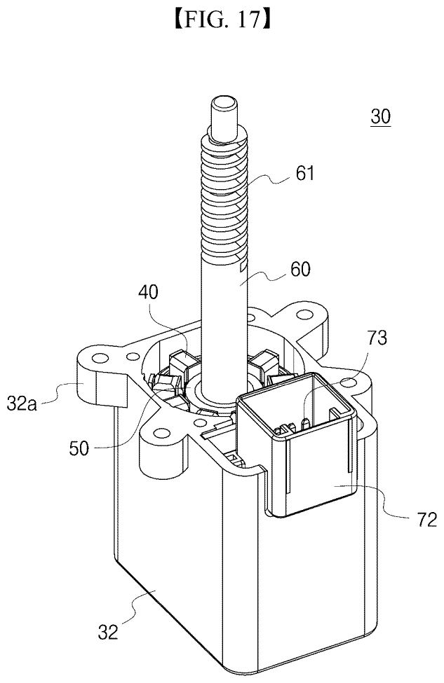

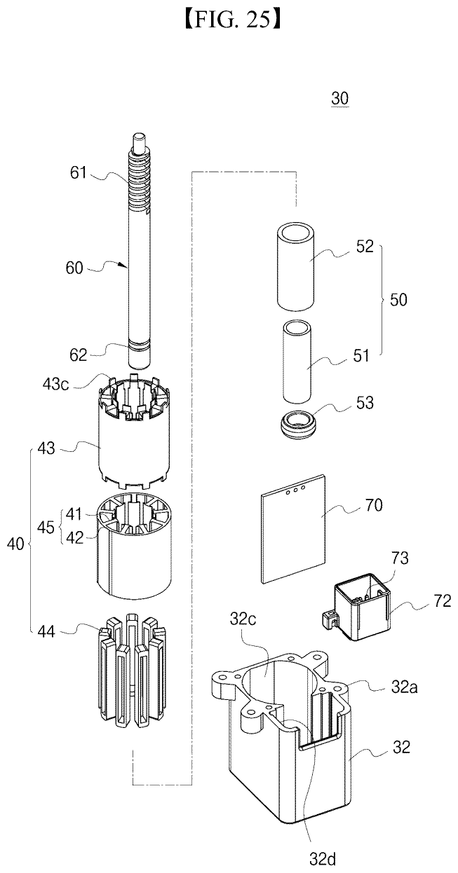

As shown in FIGS. 17 and 25, the driving motor 30 is implemented in an inner rotor type in which a rotor is arranged inside a stator, and includes a motor housing 32, a rotary shaft 60, a rotor 50, a stator 40, a printed circuit board (PCB) 70 on which electronic components having a motor driving circuit are mounted, and a connector 72.

The motor housing 32 has a rectangular cylindrical shape, and includes a first chamber 32c having a circular cross-section and a second chamber 32d having a substantially rectangular shape, and the first chamber 32c and the second chamber 32d are separated from each other.

The rotary shaft 60, the rotor 50, and the stator 40 constituting a motor are arranged in the first chamber 32c, and the PCB 70 and the connector 72 are arranged in the second chamber 32d.

A channel groove 32e forming an insertion channel for receiving either end of the PCB 70 is formed on either opposite side of the inside of the second chamber 32d.

In addition, a plurality of protrusions 32a, for example, four protrusions 32a, protrude in the vicinity of corners outside the motor housing 32 so as to be detachably coupled to the gear housing 23 of the reduction gear unit 20, and a through hole capable of fastening a fixing screw or a fixing bolt/fixing nut is formed in the center of each of the four protrusions 32a.

Further, a protrusion 34 is formed at a lower portion of the first chamber 32c of the motor housing 32 in which a two-step structure concave groove 34a for accommodating the bearing 53 and a lower end portion of the rotary shaft 60 is formed in the protrusion 34.

In addition, a circular stopper insertion groove 34b into which a stopper 54 is inserted is formed around the concave groove 34a of the first chamber 32c, and one side of the stopper 54 is inserted into the stopper insertion groove 34b, and a front end portion bent at a right angle prevents separation of the bearing 53 and the rotary shaft 60 inserted into a first-step concave groove. In this case, a front end portion of the stopper 54 is coupled to a separation prevention groove 62 formed in a ring shape at a lower end portion of the rotary shaft 60.

A lower end portion of the rotary shaft 60 is rotatably supported by the bearing 53, and an upper end portion of the rotary shaft 60 is rotatably supported by a bearing embedded in a gear housing 23 to be described later.

In addition, the rotary shaft 60 extends from the motor housing 32 so as to transfer the rotational output of the rotor 50, and a worm gear 61 is integrally formed at an upper portion of the rotary shaft 60 located inside the gear housing 23.

The rotor 50 is provided with a cylindrical back yoke 51 outside the rotary shaft 60, and a cylindrical magnet 52 is arranged outside the back yoke 51. The magnet 52 may include a plurality of N-pole and S-pole split magnet segments, or may use a magnet in which the N-pole and S-pole are split and magnetized into multiple poles in a ring-shaped magnet, and the back yoke 51 is installed on the rear surface of the magnet 52 to form a magnetic circuit.

The stator 40 includes: a stator core 45 having a plurality of teeth 41 each having a “T” shape and an annular back yoke 42 interconnected with the plurality of teeth 41 to form a magnetic circuit; a bobbin 43 made of an insulating material integrally formed to surround an outer circumferential surface on which a coil 44 of each of the plurality of teeth 41 is wound; and the coil 44 wound around the outer circumferential surfaces of the bobbin 43.

The driving motor 30 of the present invention is a radial gap type motor, and the plurality of teeth 41 of the stator core 45 and the magnet 52 of the rotor 50 face each other through an air gap.

An exposed surface of a shoe 412 of the tooth 41 facing the magnet 52 of the rotor 50 may have a “rounded (R)” shape. As a result, noise and vibration generation may be improved in the driving motor 30 of the present invention by forming an “R” in the shape of the tip of the stator core (teeth) to obtain back electromotive force (EMF) waveform in the form of a sine curve.

In addition, the bobbin 43 may be integrally formed with an insulating material so as to surround the outer circumferential surface on which the coil 44 of each of the teeth 41 is wound, or may include an upper insulator and a lower insulator respectively coupled to the upper portion and the lower portion.

In this case, when the coils 44 are wound around the three bobbins for each phase such that a BLDC motor is driven in a U, V, and W three-phase driving manner as a stator support role, a plurality of protrusions 43c used to interconnect the start wires and the end wires of the coils 44 may protrude.

The seat actuator 100 according to the present invention may include the driving motor 30, for example, a BLDC motor having a 12 pole-9 slot or 8 pole-6 slot structure. The embodiment illustrated in the drawing illustrates a BLDC motor having a 12 pole-9 slot structure.

In addition, when the coils 44 of the stator 40 in the driving motor 30 are wound on nine teeth 41 in a U, V, and W three-phase structure to construct a circuit, the coils U1 to U3, V1 to V3, and W1 to W3 wound on three teeth 41 for each phase of U, V, and W are connected in series, and when the three-phase driving circuit is connected in a Y-connection manner, the circuit diagram may be expressed as shown in FIG. 27.

FIG. 27 is a circuit diagram of an equivalent circuit of a stator coil 44 and an inverter circuit 75 of a motor driving circuit according to an embodiment of the present invention.

The nine coils U1 to U3, V1 to V3, and W1 to W3 wound around the nine teeth 41 are alternately arranged for each phase of U, V, and W to complete winding of the coils U1 to U3, V1 to V3, and W1 to W3, and then the front end portion U of the U-phase coils U1 to U3 is directly connected by soldering to the U-phase output terminal of the inverter circuit 75 mounted on the PCB 70. In the same way, the front end portion V of the V-phase coils V1 to V3 and the front end portion W of the W-phase coils W1 to W3 are directly connected to the V-phase and W-phase output terminals of the inverter circuit 75 by soldering, respectively, and the end wires of the each phase coils U1 to U3, V1 to V3, and W1 to W3 are interconnected to form a Y-connection neutral point (COM).

The PCB 70 may be connected to eight terminals 73 provided in the connector 72 to communicate with an external system and a vehicle control system. The eight terminals 73 may include, for example, Vcc, GND, a LIN communication line, and five reserved terminals. In this case, the connector 72 may be detachably assembled to the second chamber 32d of the motor housing 32 together with the PCB 70 after the electrical connection is made using the terminals 73 on the PCB 70.

Furthermore, for example, the driving motor 30 may receive a rotor position signal from two or three Hall sensors 71 in the motor driving circuit implemented in the PCB 70, and may be driven by a 6-step full-wave driving method using an inverter circuit 75.

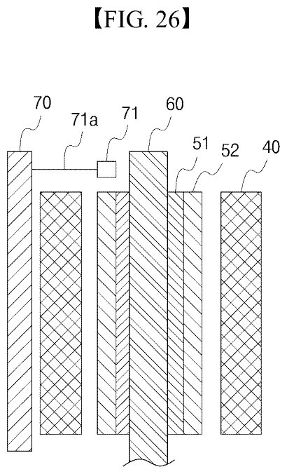

In the driving motor 30 according to the present invention, as shown in FIG. 26, a lead 71a may be extended from the lower end of the PCB 70 to a portion where the magnet 52 of the rotor 50 is located, and the Hall sensor 71 may be arranged at the front end portion of the lead 71a.

In this case, after assembling the PCB 70 in the channel concave groove 32e of the second chamber 32d of the motor housing 32, in which the lead-type Hall sensor 71 is installed at the lower end portion of the PCB 70, the rotor 50 may be subsequently assembled.

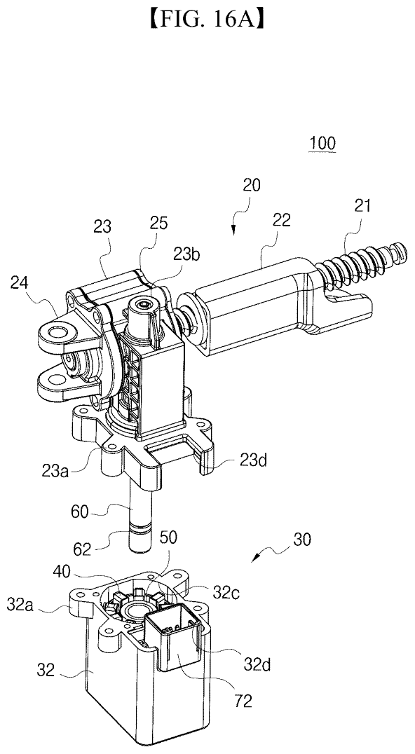

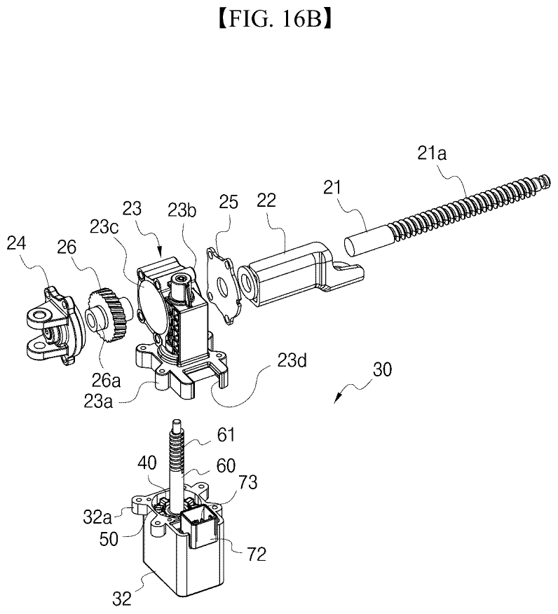

In addition, as shown in FIGS. 16A and 16B, the reduction gear unit 20 according to the present invention largely includes the gear housing 23, the worm wheel gear 26, the rear cover 24, the front cover 25, the lead screw 21, and the movable bracket 22.

The gear housing 23 has a cylindrical third chamber 23c for accommodating the worm wheel gear 26 therein and a fourth chamber 23e for accommodating the worm gear 61 extending from the rotary shaft 60 of the driving motor 30.

The front cover 25 and the rear cover 24 are coupled to front and rear sides of the third chamber 23c, respectively, and a fourth chamber 23e communicating with the third chamber 23c is arranged above the first chamber 32c of the motor housing 32 to communicate with each other.

The worm wheel gear 26 has a hollow shaft 26a formed in the center thereof, and one end portion of the hollow shaft 26a is rotatably supported by a bearing installed on the rear cover 24.

Additionally, one end portion of the lead screw 21 is connected to the hollow shaft 26a of the worm wheel gear 26 through a through hole formed in the center of the front cover 25, and a screw portion 21a of the lead screw 21 is equipped with the movable bracket 22 with a female thread formed inside.

The gear housing 23 has a flat surface so that the lower end portion of the gear housing 23 may be coupled to the upper portion of the motor housing 32, four protrusions 23a corresponding to the four protrusions 32a of the motor housing 32 protrude near the corners, and each of the four protrusions 23a has a through hole for fastening a fixing screw or fixing bolt/fixing nut in the center of the through hole.

In addition, a pair of protrusions protrudes from both ends on one side surface of the gear housing 23, to form an accommodation groove 23d for accommodating the upper portion of the connector 72 of the driving motor 30.

In the reduction gear unit 20 according to the present invention, the worm wheel gear 26 is gear-coupled to the worm gear 61 extending from the rotary shaft 60 of the driving motor 30 to perform deceleration. When the worm wheel gear 26 is decelerated, the torque increases and the movable bracket 22 coupled to the screw portion 21a of the lead screw 21 moves forward or backward in a straight line along the screw portion 21a.

In this case, the screw portion 21a and the movable bracket 22 may be configured as a ball screw and a ball nut for a small backlash and a linear motion.

When the seat actuator 100 according to the present invention is applied for the legrest actuators 13a and 13b, the recliner actuator 12a, and the relaxation actuator 11a applied to the vehicle seat, one of the legrest, the seat cushion, and the seatback in which the movable bracket 22 is operated is installed or connected to perform a linear motion or a rotational motion.

While the present invention has been particularly shown and described with reference to exemplary embodiments thereof, by way of illustration and example only, it is clearly understood that the present invention is not to be construed as limiting the present invention, and various changes and modifications may be made by those skilled in the art within the protective scope of the invention without departing off the spirit of the present invention.

### INDUSTRIAL APPLICABILITY

The seat actuator of the present invention may be applied to a legrest actuator, a recliner actuator, a relaxation actuator, or the like, which is applied to a vehicle seat, and may also be applied to a field other than a seat.

What is claimed is:

1. A driving motor for a seat actuator, the driving motor comprising:
a motor housing having a first chamber and a second chamber interconnected with each other inside a container and divided into sections;
a rotary shaft which is rotatably arranged at the center of the first chamber, and which has a first worm gear integrally formed in an extension part extending to the outside of the first chamber;
a rotor having a back yoke and a ring-shaped magnet arranged on the outer circumference of the rotary shaft;
a stator arranged on the outside of the rotor with an air gap therebetween, and arranged on the outer circumferential portion of the first chamber in order to rotatably drive the rotor by generating a rotating magnetic field; and
a printed circuit board (PCB) which is arranged to cover the tops of the first chamber and the second chamber, and on which a plurality of electronic components having a motor driving circuit for applying a driving signal to U, V, and W three-phase coils of the stator are mounted.

2. The driving motor of claim 1, further comprising a plurality of Hall sensors each mounted on a lower surface of the PCB and configured to be positioned close to a portion where the magnet of the rotor is located, wherein the driving motor is a brushless direct-current (BLDC) motor driven by a 6-step full-wave driving method using an inverter of the motor driving circuit after receiving a rotor position signal from the plurality of Hall sensors.

3. The driving motor of claim 1, wherein, when the U, V, and W three-phase coils of the stator are wound around a plurality of teeth, and the each-phase coils are connected in series, a start wire of each of the U, V, and W three-phase coils is press-fitted and coupled to the PCB using a press fit terminal.

4. The driving motor of claim 1, wherein an end wire of each of the U, V, and W three-phase coils forms a Y-connection neutral point (COM) using a mag mate wiring box.

5. The driving motor of claim 1, further comprising a connector installed in the second chamber of the motor housing and connected to the PCB through a plurality of terminals to communicate with a control system of the vehicle, wherein the plurality of terminals include power supply voltage Vcc, ground voltage GND, and local interconnect network (LIN) communication line.

6. The driving motor of claim 1, wherein the stator comprises:
a stator core including a plurality of teeth each having a T-shaped front end portion extending in an axial direction and a back yoke interconnected to the plurality of teeth to form a magnetic circuit;
upper and lower insulators surrounding a coil winding region of each of the plurality of teeth by half in upper and lower portions thereof; and
a coil wound around an outer circumferential surface of each of the upper and lower insulators, wherein each of the upper and lower insulators comprises:
an annular base frame having a predetermined width; and
a plurality of teeth accommodating portions protruding from the base frame and receiving the winding regions of the teeth from the upper portion and the lower portion by half.

7. The driving motor of claim 1, wherein a connector housing is integrally formed in the motor housing forming the second chamber, and is connected to the PCB through a plurality of terminals integrally formed in the connector housing to communicate with a control system of the vehicle.

8. The driving motor of claim 1, further comprising:
a bearing that rotatably supports a lower end portion of the rotary shaft;
a protrusion having a two-stage structure groove formed in the lower portion of the first chamber of the motor housing for accommodating the bearing and the lower end portion of the rotary shaft; and
a stopper having one side inserted into a stopper insertion groove arranged around the groove to prevent the bearing and the rotary shaft from being separated, wherein a front end portion of the stopper is coupled to a separation preventing groove formed in a ring shape at the lower end portion of the rotary shaft.

9. A seat actuator comprising:
a motor housing having a first chamber and a second chamber interconnected with each other inside a container and divided into sections;
a gear housing having a cylindrical third chamber assembled to the upper portion of the motor housing and interconnected to each other inside a container and divided into sections, and a cylindrical fourth chamber orthogonal to the cylinder of the third chamber and arranged on the same axis as the first chamber;
rear and front covers respectively coupled to the rear and front of the gear housing;
an inner rotor type driving motor arranged in the first chamber of the motor housing and having a first worm gear integrally formed in an extension part extending from the first chamber to the fourth chamber; and
a reduction gear unit accommodated in the third chamber and having a worm wheel gear coupled to an outer circumference of the first worm gear to generate a deceleration output in a hollow shaft installed at the center thereof, wherein
the deceleration output of the reduction gear unit linearly moves forward or backward a movable bracket screw-coupled to a lead screw having one end coupled to the hollow shaft.

10. The seat actuator of claim 9, wherein the driving motor comprises:
a motor housing having a first chamber and a second chamber interconnected with each other inside a container and divided into sections;
a rotary shaft which is rotatably arranged at the center of the first chamber, and which has a first worm gear integrally formed in an extension part extending to the outside of the first chamber;
a rotor having a back yoke and a ring-shaped magnet arranged on the outer circumference of the rotary shaft;
a stator arranged on the outside of the rotor with an air gap therebetween, and arranged on the outer circumferential portion of the first chamber in order to rotatably drive the rotor by generating a rotating magnetic field; and
a printed circuit board (PCB) which is arranged in the inside of the second chamber adjacent to the first chamber, and on which a plurality of electronic components having a motor driving circuit for applying a driving signal to U, V, and W three-phase coils of the stator are mounted, wherein the driving motor is a brushless direct-current (BLDC) motor.

11. The seat actuator of claim 9, wherein the reduction gear unit comprises:
a gear housing having a cylindrical third chamber interconnected to each other inside the container and divided into sections, and a cylindrical fourth chamber orthogonal to the cylinder of the third chamber and arranged on the same axis as that of the first chamber;
a worm wheel gear accommodated in the third chamber, having a hollow shaft installed in a central portion thereof, and having an outer circumferential portion gear-coupled to an outer circumference of the first worm gear to generate a deceleration output;
a rear cover coupled to the rear of the third chamber and rotatably supporting one end of the hollow shaft;
a front cover coupled to the front of the third chamber and having a through hole formed in the center thereof;
a bearing installed in the third chamber to rotatably support the other end of the hollow shaft; and
a lead screw having one end coupled to the hollow shaft of the worm wheel gear through the through hole of the front cover, and configured to linearly move forward or backward the movable bracket screw-coupled to a screw portion while rotating in conjunction with the rotation of the worm wheel gear.

12. The seat actuator of claim 9, wherein the movable bracket is connected to one of a legrest, a seat cushion, and a seatback in which movable operation is performed in a seat for a vehicle.

13. The seat actuator of claim 9, wherein the motor housing and the gear housing are detachably coupled to each other.

14. The seat actuator of claim 9, wherein an upper housing coupled to an upper portion of the motor housing is integrally formed under the gear housing.

15. The seat actuator of claim 9, further comprising a pair of protrusions protruding from both ends of one side surface of the gear housing to form an accommodation groove for accommodating an upper portion of the connector of the driving motor.
